(19) United States
(12) Patent Application Publication
(10) Pub. No.: US 2015/0292731 A1
(43) Pub. Date: Oct. 15, 2015

(54) Telescopically Actuated Audible Lantern

(71) Applicants: Robert Rutger, Sarasota, FL (US); James Michael Garasz, Brandon, FL (US)

(72) Inventors: Robert Rutger, Sarasota, FL (US); James Michael Garasz, Brandon, FL (US)

(21) Appl. No.: 14/685,220

(22) Filed: Apr. 13, 2015

Related U.S. Application Data
(60) Provisional application No. 61/978,575, filed on Apr. 11, 2014.

(51) Int. Cl. F21V 33/00; F21L 4/04; H04R 1/02; F21V 23/00; F21V 23/04; F21L 14/02; F21V 21/22

(52) U.S. Cl. CPC F21V 33/0056; F21L 14/02; F21L 4/04; F21V 21/22; F21V 23/005; F21V 23/0428; H04R 1/028; F21Y 2101/02

(57) ABSTRACT

A portable lantern includes a sound producing feature in addition to aesthetically pleasing illumination. The lantern includes a structural tube, a sleeve, a power source, a trip switch, at least one light emitter, at least one speaker, a microcontroller, and a base cap. The power source is electrically connected to the microcontroller. The microcontroller is in turn electronically connected to the light emitter(s), the speaker(s), and the trip switch. The electronic components are mounted within the structural tube. The structural tube is in turn housed within and telescopically engaged to the sleeve. The sleeve is closed off on one end by the base cap. The trip switch is externally mounted to the structural tube, located within the sleeve. In the extended configuration the trip switch activates the light emitter(s) and the speakers(s). Various tunes and sounds may be produced by the device, depending on the preferences of the user.

The current application claims a priority to the U.S. Provisional Patent application Ser. No. 61/978,575 filed on Apr. 11, 2014. The current application is filed on Apr. 13, 2015 while Apr. 11, 2015 was on a weekend.

### FIELD OF THE INVENTION

The present invention relates generally to a lantern with an internal illuminating source and audio source. More specifically, the present invention is a telescoping lantern with internal illumination and audio playback that are engaged by drawing the lantern into an extended configuration.

### BACKGROUND OF THE INVENTION

Illuminated and sound-making novelty devices have increased in popularity in recent years. Many of these devices have become more popular as a result of the decrease in cost for solid-state illumination devices, such as light-emitting diodes (LED). LED lighting requires much less power than conventional means of illumination such as incandescent lamps as well as portable power sources such as rechargeable and non-rechargeable batteries. Additionally, LEDs often feature much longer life spans, thus reducing the overall costs for novelty illumination in particular as the LEDs do not often require replacement. These conditions have produced a variety of novelty devices which produce light and sound.

The present invention is a novel device which integrates sound production into a lantern design. The present invention activates sound production and the illumination in response to being positioned into the extended configuration and turn off said features when positioned into a collapsed configuration. Additional features of the present invention include a means for uploading audio files such that the user may customize the sound produced by the lantern. Another feature includes real-time audio streaming through the use of a wireless communication device being paired to an audio device.

### BRIEF DESCRIPTION OF THE DRAWINGS

FIG. 1 is a perspective view of the present invention in the collapsed configuration.

FIG. 2 is a perspective view of the present invention in the extended configuration.

FIG. 3 is a perspective exploded view of the present invention.

FIG. 4 is a front view of the present invention in the extended configuration.

FIG. 5 is a cross-sectional cut view taken along line A-A shown in FIG. 4, depicting the present invention in the extended configuration.

FIG. 6 is a detailed view taken about the circle B shown in FIG. 5.

FIG. 7 is a cross-sectional cut view taken along line A-A shown in FIG. 4, depicting the present invention in the collapsed configuration.

FIG. 8 is a perspective exploded view of the present invention depicting the opaque tube, wherein the opaque tube is placed within the structural tube.

FIG. 9 is a schematic diagram of the electronic components of the present invention.

### DETAIL DESCRIPTIONS OF THE INVENTION

All illustrations of the drawings are for the purpose of describing selected versions of the present invention and are not intended to limit the scope of the present invention.

The present invention is a lantern that illuminates and produces sounds. More specifically, the present invention is a portable light source that produces a variety of sounds. The present invention may be positioned into two configurations, a collapsed configuration and an extended configuration. In the collapsed configuration, the present invention does not emit light nor produce sound; this is used for storage to prevent the internal battery from dying. In the extended configuration, the present invention acts as a light source and produces a variety of sounds.

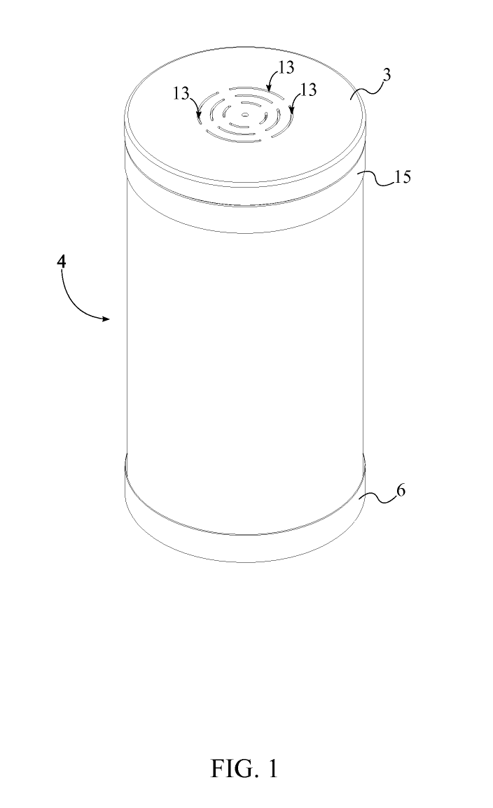

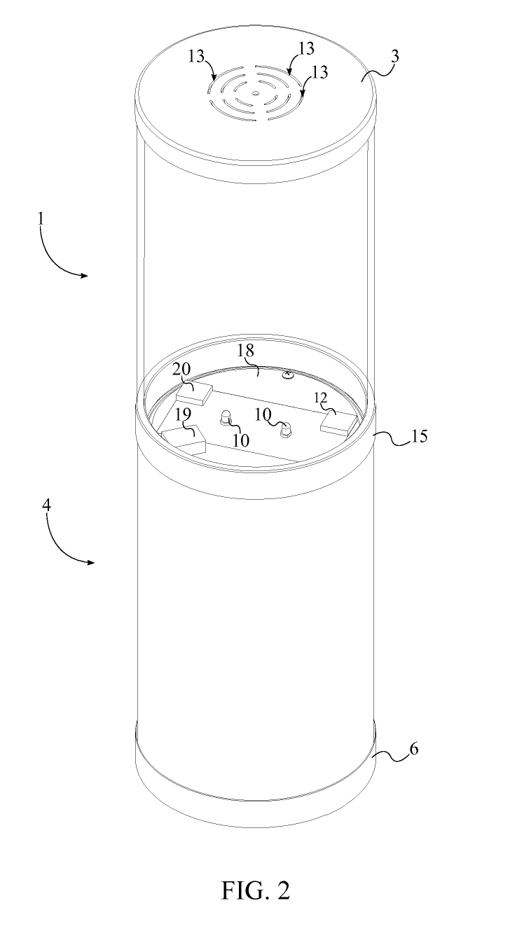

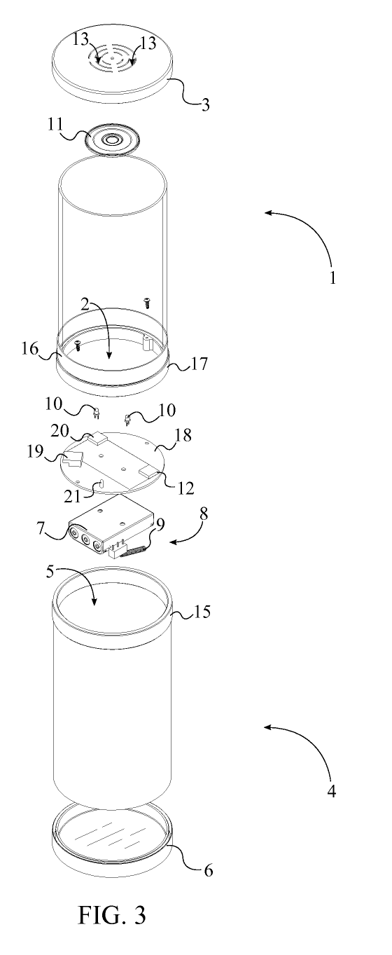

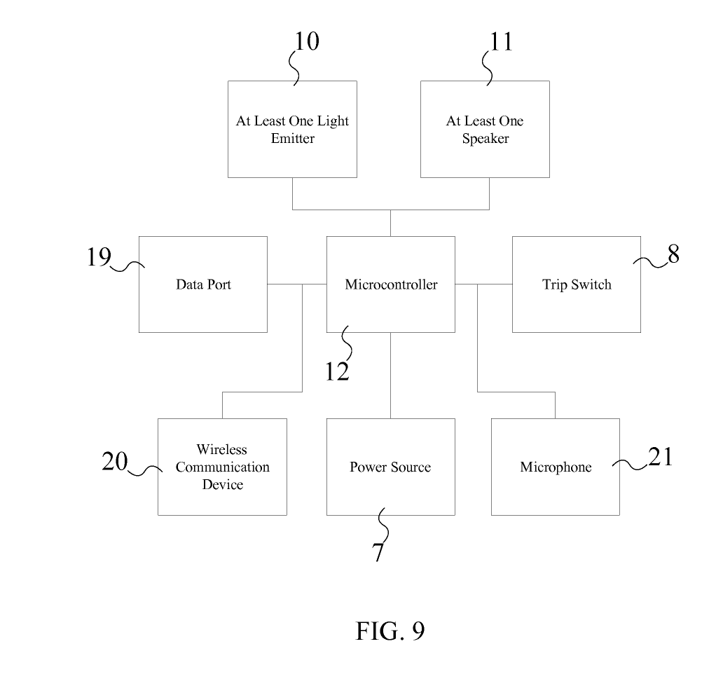

Referring to FIG. 1, FIG. 2, and FIG. 3, the present invention comprises a power source 7, a trip switch 8, at least one light emitter 10, at least one speaker 11, a microcontroller 12, a structural tube 1, a sleeve 4, and a base cap 6. The power source 7 is electrically connected to the microcontroller 12 and provides the necessary electrical energy required for the various functions of the present invention. In one embodiment, the power source 7 is a rechargeable battery. In another embodiment, the power source 7 is in the form of an electric outlet, in which case the internal electric components would be modified to be powered by an alternative current. The microcontroller 12 is in turn electronically connected to the at least one light emitter 10, the at least one speaker 11, and the trip switch 8 as seen in FIG. 9. The microcontroller 12 controls the flow of electricity to said components and therefore controls the various functions of the present invention including, but not limited to, the sounds produced by the at least one speaker 11 and the light produced by the at least one light emitter 10. Various sounds, songs, and music tunes may be stored on the microcontroller 12 and produced by the at least one speaker 11. The at least one speaker 11 is an electroacoustic transducer; an electronic device that converts electric signals into corresponding sounds. The at least one light emitter 10 is a device which produces light from electricity. The present invention preferably utilizes a light-emitting diode (LED) as the at least one light emitter 10. However, the present invention is not limited to LED and can be any other type of device that functions as a battery operated light source. The structural tube 1 protects and houses the various components of the present invention and comprises a tube open end 2 and a top end cap 3. The top end cap 3 and the tube open end 2 are positioned opposite to each other along the structural tube 1. The top end cap 3 protects the internal components of the structural tube 1 from environmental factors and increases the longevity of the electric components as the microcontroller 12, the at least one light emitter 10, the power source 7, and the at least one speaker 11 are mounted within the structural tube 1.

The sleeve 4 houses the structural tube 1 and the associated components mounted within. The sleeve 4 is closed off at one end by a base cap 6 and opened to the exterior environment at the other end with a sleeve open end 5. The base cap 6 is mounted adjacent to the sleeve 4 and is sized to the diameter of the sleeve 4 such that the base cap 6 fits over the sleeve 4. The sleeve open end 5 is positioned opposite to the base cap 6 along the sleeve 4 and facilitates the placement of the structural tube 1 within the sleeve 4. The tube open end 2 is positioned within the sleeve 4 so that the tube open end 2 is able to telescopically engage into the sleeve 4, opposite of the base cap 6. The telescoping engagement allows for relative vertical motion between the structural tube 1 and the sleeve 4. This design allows the present invention to be arranged into the collapsed configuration and the extended configuration. In the collapsed configuration, the sleeve 4 covers and protects the structural tube 1. In the extended configuration, the sleeve 4 vertically supports the structural tube 1. The trip switch 8 activates the internal electronic components of the present invention to produce light and sound once the present invention is positioned into the extended configuration. The trip switch 8 is positioned adjacent to the tube open end 2 and is externally mounted to the structural tube 1.

The extended configuration for the structural tube 1 and the sleeve 4 is shown in

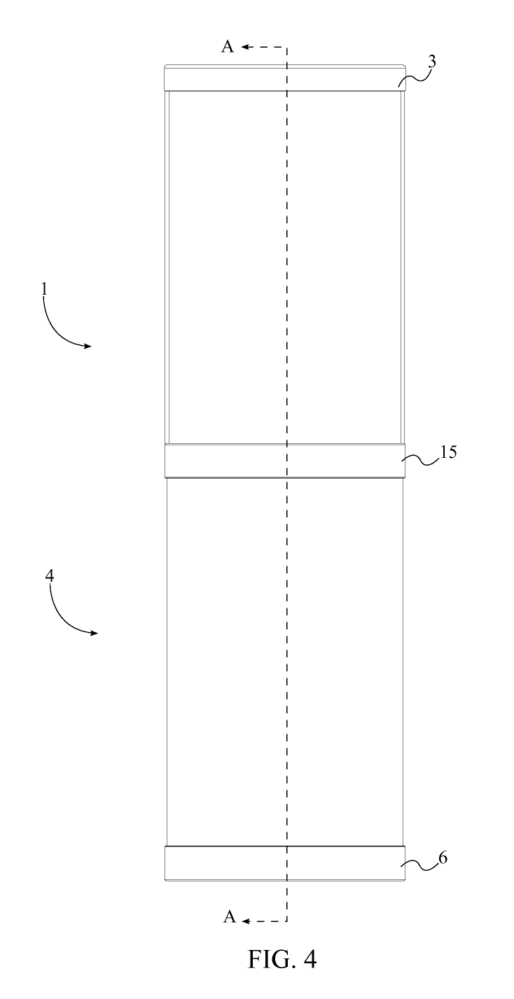

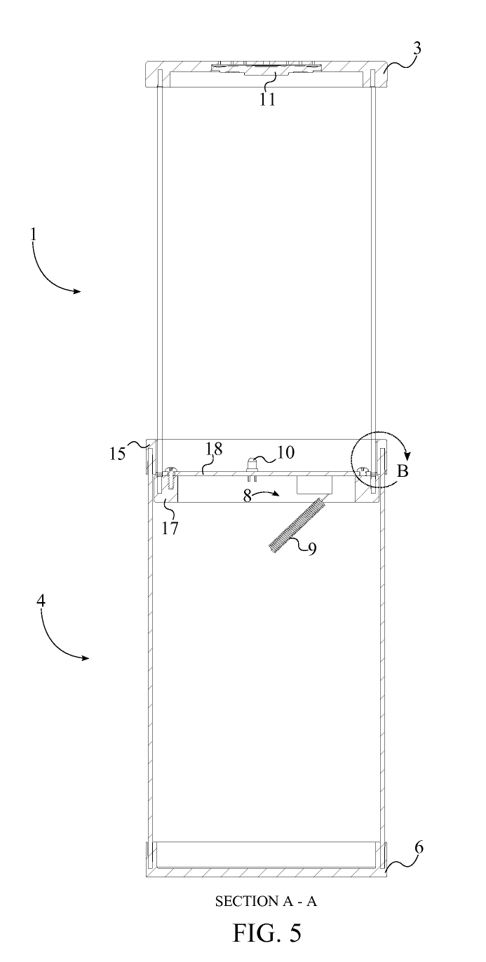

FIG. 2, FIG. 4, and FIG. 5. In the extended configuration, the tube open end 2 is positioned adjacent to the sleeve open end 5, extending the structural tube 1 outside of the sleeve 4 to its fullest extent as seen in FIG. 2. The extended configuration triggers the illumination and sound production functions of the present invention. The collapsed configuration for the structural tube 1 and the sleeve 4 deactivates the internal electrical components of the present invention. A sleeve lip seal 15 and a tube lip seal 17 are used to interlock the structural tube 1 and the sleeve 1 to prevent one from being disengaged from the other. The sleeve lip seal 15 is concentrically connected to the sleeve 4, adjacent to the sleeve open end 5. The tube lip seal 17 is concentrically connected to the structural tube 1, adjacent to the tube open end 2. In the extended configuration, the sleeve lip seal 15 and the tube lip seal 17 are vertically engaged, preventing the structural tube 1 from being pulled out of the sleeve 4.

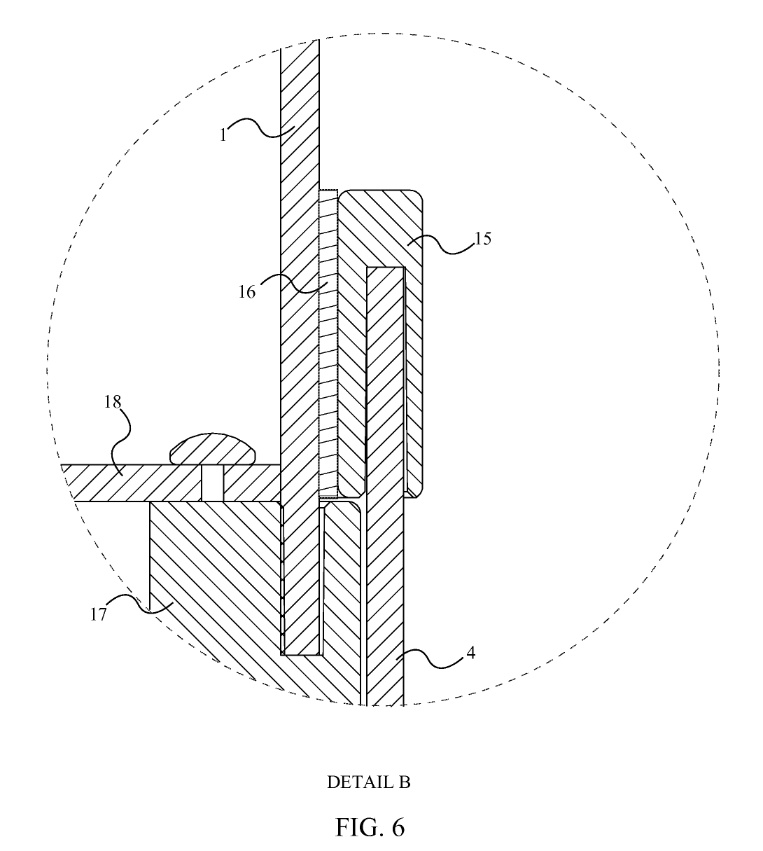

In the collapsed configuration, the structural tube 1 is fully inserted into the sleeve 4, where the tube open end 2 is positioned adjacent to the base cap 6. In the collapsed configuration, the at least one speaker 11 and at least one light emitter 10 are deactivated to save energy. Once the present invention is positioned into the extended configuration, it is held there through the use of a locking mechanism. The preferred locking mechanism is an annular gasket 16. The annular gasket 16 is laterally connected around the structural tube 1, adjacent to the tube lip seal 17. In the extended configuration, the annular gasket 16 is pressed against the sleeve lip seal 15 by the structural tube 1 as seen in FIG. 6. This engagement increases the friction in between the annular gasket 16 and the structural tube 1 such that the two components are locked together. To position the present invention into the extended configuration, the user simply pulls the structural tube 1 away from the sleeve 4 to its fullest extent such that the annular gasket 16 engages the structural tube 1 and locks the two components.

In alternative embodiments of the present invention, different locking mechanisms may be used to secure the structural tube 1 and the sleeve 4 into the extended configuration. Locking mechanisms include, but are not limited to, pin—slot mechanisms, buttons, latches, and screws. In one embodiment, the locking mechanism is a combination of an annular lip and a complimentary annular recession. The annular lip is perimetrically connected about the sleeve 4, adjacent to the sleeve open end 5. The annular recession is internally and laterally traversing into the structural tube 1, adjacent to the tube open end 2. The annular recession and annular lip are sized such that a complimentary male-female fit is achieved when the two components are aligned. The extended configuration is held in place by the annular lip being physically engaged to the annular recession. In another embodiment, the annular lip and annular recession engagement is replaced by a female and male threading. The outer surface of the structural tube 1 would contain external threads and the inner surface of the sleeve 4 would contains corresponding thread recessions. In this embodiment, the user simply rotates the structural tube 1 relative to the sleeve 4 to reach either the extended configuration or collapsed configuration, depending on the direction of rotation.

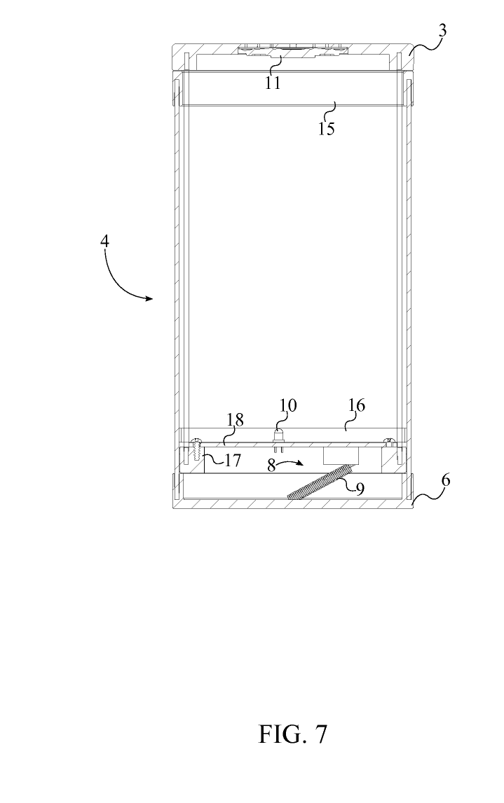

The internal electric components of the present invention are activated and deactivated through the usage of the trip switch 8. The trip switch 8 is an electric switch, which creates a break in an electric circuit, most often used to cut off power to the electric components in a circuit. As described above, the trip switch 8 is externally mounted to the structural tube 1, adjacent to the tube open end 2. More specifically, the trip switch 8 is mounted onto a housing plate 18, which is in turn connected to the structural tube 1. The trip switch 8 is also integrated into the electric circuit of the present invention as mentioned above. The trip switch 8 is configured such that in the collapsed configuration a deactivation lever 9 of the trip switch 8 is pressed against the base cap 6 and deactivates the various electric components of the present invention as seen in FIG. 7. When the present invention is positioned into the extended configuration, the deactivation lever 9 is released and the various electric components of the present invention are activated as seen in FIG. 5. This design activates the illumination and sound features of the present invention when positioned into the extended configuration and deactivates said features when positioned into the collapsed configuration. Alternative types of electric switches may be used for the trip switch 8 including, but not limited to, simple electric buttons and touch sensors.

The electrical components mounted within the structural tube 1 are more specifically mounted onto the housing plate 18. The housing plate 18 is sized to the internal diameter of the structural tube 1 and is perimetrically and internally attached to the structural tube 1, adjacent to the tube open end 2 as seen in FIG. 2 and FIG. 3. The microcontroller 12, the at least one light emitter 10, and the power source 7 are mounted onto the housing plate 18. Alternatively, the at least one speaker 11 is mounted within the structural tube 1 and is positioned adjacent to the top end cap 3 to facilitate sound propagation. A plurality of holes 13 traverses through the top end cap 3 to further aid in sound propagation. The at least one speaker 11 is more specifically positioned adjacent to the plurality of holes 13.

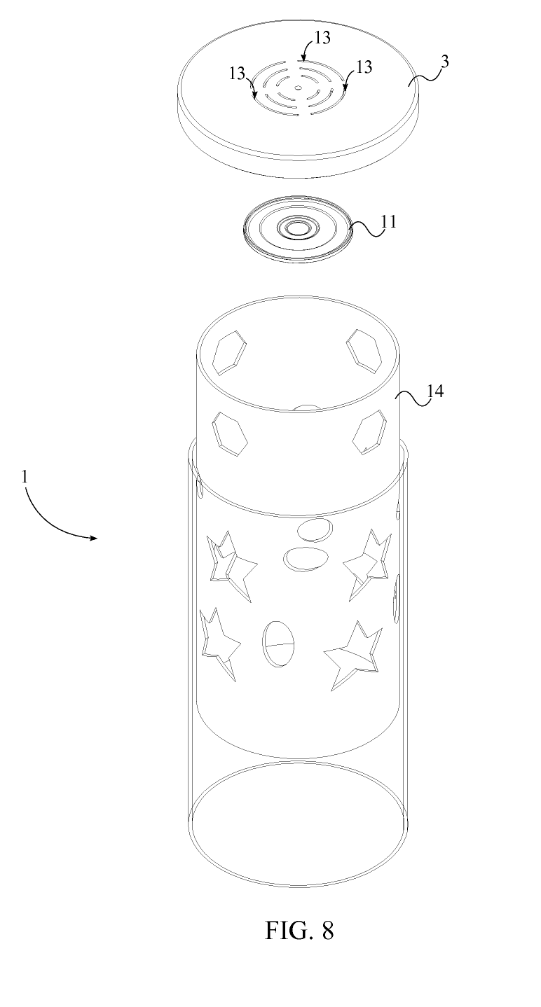

In addition to acting as a light source and producing sounds/music, the present invention also projects aesthetically pleasing illustrations. This is achieved through the use of an illumination sheet 14 that is configured into a tubular shape as seen in FIG. 8. The structural tube 1 is preferably made out of translucent material to allow for maximum light penetration. The illumination sheet 14 is concentrically positioned with the structural tube 1. In one embodiment, the illumination sheet 14 is externally positioned around the structure tube 1. In another embodiment, the illumination sheet 14 is internally positioned within structural tube 1. In yet another embodiment, the illumination sheet 14 is positioned within the walls of the structural tube 1. The illumination sheet 14 may contain a plurality of various designs, items, drawings, scenes, and geometric outlines to name a few non-limiting examples. When the at least one light emitter 10 is turned on, the light passes through the illumination sheet 14 creating an aesthetically pleasing illumination.

In one embodiment of the present invention, a data port 19 is utilized to allow the user to import specific audio files into the present invention, further customizing the present invention to the user's preference. One example for the data port 19 is a universal serial bus (USB) port, although alternative connector may also be used. The data port 19 is internally mounted within the structural tube 1 by the housing plate 18. Additionally, the data port 19 is electronically connected to the microcontroller 12. The user may take apart the structural tube 1 and download his or her audio files to the microcontroller 12 through the data port 19. In another embodiment, a similar feature is integrated into the present invention through the user of a wireless communication device 20. The preferred wireless communication device 20 is a wireless networking device for exchanging data over short distances, although alternative devices may also be used. Similar to the data port 19, the wireless communication device 20 is internally mounted within the structural tube 1 by the housing plate 18 and electronically connected to the microcontroller 12. Through the use of the wireless communication device 20 the user may download audio files to the microcontroller 12 and/or stream said music directly to the microcontroller 12 in real-time. In yet another embodiment of the present invention, a microphone 21 is integrated into the present invention to allow the user to record sounds; recordings may then be played through the at least one speaker 11. The microphone 21 is internally mounted within the structural tube 1 by the housing plate 18 and is electronically connected to the microcontroller 12. In one embodiment of the present invention, a tubular sheet of organic LEDs is placed within the structural tube 1 to display various scenes and lights depending on the liking of the user. The tubular sheet of organic LEDs is a film of organic compounds which produce a variety of different lights when an electric current is run through the film. This embodiment would allow for a highly customizable and more aesthetically pleasing illumination.

Although the invention has been explained in relation to its preferred embodiment, it is to be understood that many other possible modifications and variations can be made without departing from the spirit and scope of the invention as hereinafter claimed.

What is claimed is:

1. A telescopically-actuated audible lantern comprises:
a structural tube;
a sleeve;
a power source;
a trip switch;
at least one light emitter;
at least one speaker:
a microcontroller;
a base cap;
the power source being electrically connected to the microcontroller;
the microcontroller being electronically connected the at least one light emitter, the at least one speaker, and the trip switch;
the microcontroller, the at least one light emitter, the power source, and the at least one speaker being mounted within the structural tube;
the base cap being mounted adjacent to the sleeve;
a tube open end of the structural tube being positioned within the sleeve;
the tube open end of the structural tube being telescopically engaged into the sleeve, opposite to the base cap;
the trip switch being positioned adjacent to the tube open end; and
the trip switch being externally mounted to the structural tube.

2. The telescopically-actuated audible lantern as claimed in claim 1 comprises:
a plurality of holes;
the structural tube further comprises a top end cap;
the top end cap and the tube open end being positioned opposite to each other along the structural tube;
the plurality of holes traversing through the top end cap; and
the at least one speaker being positioned adjacent to the plurality of holes.

3. The telescopically-actuated audible lantern as claimed in claim 1 comprises:
an illumination sheet; and,
the illumination sheet being concentrically positioned with the structural tube.

4. The telescopically-actuated audible lantern as claimed in claim 1 comprises:
an annular gasket;
a sleeve lip seal;
a tube lip seal;
the sleeve further comprises a sleeve open end;
the sleeve lip seal being concentrically connected to the sleeve, adjacent to the sleeve open end;
the tube lip seal being concentrically connected to the structural tube, adjacent to the tube open end; and
the annular gasket being laterally connected around the structural tube, adjacent to the tube lip seal.

5. The telescopically-actuated audible lantern as claimed in claim 4 comprises:
wherein the structural tube is in an extended configuration with the sleeve;
the tube open end being positioned adjacent to the sleeve open end; and
the annular gasket being pressed against the sleeve lip seal by the structural tube.

6. The telescopically-actuated audible lantern as claimed in claim 4 comprises:
wherein the structural tube is in a collapsed configuration with the sleeve;
the tube open end being positioned adjacent to the base cap; and
a deactivation lever of the trip switch being pressed against the base cap.

7. The telescopically-actuated audible lantern as claimed in claim 1, wherein the structural tube is made out of translucent material.

8. The telescopically-actuated audible lantern as claimed in claim 1 comprises:
a housing plate;
the housing plate being perimetrically and internally attached to the structural tube, adjacent to the tube open end; and
the microcontroller, the at least one light emitter, the trip switch, and the power source being mounted onto the housing plate.

9. The telescopically-actuated audible lantern as claimed in claim 1 comprises:
a data port;
the data port being internally mounted within the structural tube by a housing plate; and
the data port being electronically connected to the microcontroller.

10. The telescopically-actuated audible lantern as claimed in claim 1 comprises:
a wireless communication device;
the wireless communication device being internally mounted within the structural tube by a housing plate; and
the wireless communication device being electronically connected to the microcontroller.

11. The telescopically-actuated audible lantern as claimed in claim 1 comprises:
a microphone;
the microphone being internally mounted within the structural tube by a housing plate; and
the microphone being electronically connected to the microcontroller.

12. An telescopically-actuated audible lantern comprises:
a structural tube;
a sleeve;
a power source;
a trip switch;
at least one light emitter;
at least one speaker:
a microcontroller;
a base cap;
an illumination sheet;
the power source being electrically connected to the microcontroller;
the microcontroller being electronically connected the at least one light emitter, the at least one speaker, and the trip switch;
the microcontroller, the at least one light emitter, the power source, and the at least one speaker being mounted within the structural tube;
the base cap being mounted adjacent to the sleeve;
a tube open end of the structural tube being positioned within the sleeve;
the tube open end of the structural tube being telescopically engaged into the sleeve, opposite to the base cap;
the trip switch being positioned adjacent to the tube open end;
the trip switch being externally mounted to the structural tube; and
the illumination sheet being concentrically positioned with the structural tube.

13. The telescopically-actuated audible lantern as claimed in claim 12 comprises:
a plurality of holes;
the structural tube further comprises a top end cap;
the top end cap and the tube open end being positioned opposite to each other along the structural tube;
the plurality of holes traversing through the top end cap; and
the at least one speaker being positioned adjacent to the plurality of holes.

14. The telescopically-actuated audible lantern as claimed in claim 12 comprises:
an annular gasket;
a sleeve lip seal;
a tube lip seal;
the sleeve further comprises a sleeve open end;
the sleeve lip seal being concentrically connected to the sleeve, adjacent to the sleeve open end;
the tube lip seal being concentrically connected to the structural tube, adjacent to the tube open end; and,
the annular gasket being laterally connected around the structural tube, adjacent to the tube lip seal.

15. The telescopically-actuated audible lantern as claimed in claim 14 comprises:
wherein the structural tube is in an extended configuration with the sleeve;
the tube open end being positioned adjacent to the sleeve open end; and
the annular gasket being pressed against the sleeve lip seal by the structural tube.

16. The telescopically-actuated audible lantern as claimed in claim 14 comprises:
wherein the structural tube is in a collapsed configuration with the sleeve;
the tube open end being positioned adjacent to the base cap; and
a deactivation lever of the trip switch being pressed against the base cap.

17. The telescopically-actuated audible lantern as claimed in claim 12, wherein the structural tube is made out of translucent material.

18. The telescopically-actuated audible lantern as claimed in claim 12 comprises:
a housing plate;
the housing plate being perimetrically and internally attached to the structural tube, adjacent to the tube open end; and
the microcontroller, the at least one light emitter, the trip switch, and the power source being mounted onto the housing plate.

19. The telescopically-actuated audible lantern as claimed in claim 12 comprises:
a data port;
the data port being internally mounted within the structural tube by a housing plate; and
the data port being electronically connected to the microcontroller.

20. The telescopically-actuated audible lantern as claimed in claim 12 comprises:
a wireless communication device;
a microphone;
the wireless communication device being internally mounted within the structural tube by a housing plate;
the wireless communication device being electronically connected to the microcontroller;
the microphone being internally mounted within the structural tube by the housing plate; and
the microphone being electronically connected to the microcontroller.
